(19) United States
(12) Patent Application Publication
(10) Pub. No.: US 2022/0209563 A1
(43) Pub. Date: Jun. 30, 2022

(54) ADAPTIVE BATTERY CHARGING BASED ON RELAXATION VOLTAGE MEASUREMENTS

(71) Applicant: Gbatteries Energy Canada Inc., Ottawa (CA)

(72) Inventors: Mykola Sherstyuk, Ottawa (CA); Mikhail Prokoptsov, Kanata (CA)

(73) Assignee: Gbatteries Energy Canada Inc., Ottawa, ON (CA)

(21) Appl. No.: 17/609,132

(22) PCT Filed: May 8, 2020
(86) PCT No.: PCT/CA2020/050632

§ 371 Date: Nov. 5, 2021

Related U.S. Application Data
(60) Provisional application No. 62/846,097, filed on May 10, 2019.

(51) Int. Cl. H02J 7/00

(52) U.S. Cl. CPC H02J 7/00711; H02J 7/007184; H02J 7/007194; H02J 7/005; H02J 7/0069; H02J 7/0048

(57) ABSTRACT

Disclosed are methods, systems, and devices to adaptively charge a battery. Charging current is applied to charge the battery. After application of the charging current, at least one discharging pulse is applied to the battery, and in response to application of the at least one discharging pulse, a first value and a second value of a relaxation voltage of the battery is determined. The first value corresponds to a maximum value of the relaxation voltage, and the second value corresponds to a value of the relaxation voltage determined after a particular wait period following the application of the at least one discharging pulse. Based on a difference between the first value and the second value of the relaxation voltage, one or more charging parameters are adapted, and the battery is charged based on the adapted one or more charging parameters.

### CROSS REFERENCE TO RELATED APPLICATIONS

This application is a National Stage filing under 35 U.S.C. § 371 of International Application No. PCT/CA2020/050632, filed on May 8, 2020, which claims priority to U.S. Provisional Patent Application No. 62/846,097, filed on May 10, 2019, the contents of both applications are incorporated herein by reference in their entirety for all purposes.

### TECHNICAL FIELD

The present specification relates to battery charging, and in particular to adaptive battery charging based on relaxation voltage measurements.

### BACKGROUND

Advancements in battery technology have not kept up with market demand. There is a need to improve performance of battery systems. In particular, there is a need to improve a speed of charging of a battery as well as a life of the battery (in terms of years and in terms of charge/discharge cycles).

Some existing battery charging methods include using relaxation voltage measurements to adapt the charging process, however such methods have some limitations. One such adaptive battery charging method is disclosed in U.S. Pat. No. 9,385,555, which includes determining relaxation time of a battery/cell which may be characterized as a decay of the terminal voltage, in response to the termination or removal of a current signal, from a peak terminal voltage to an equilibrium or pseudo-equilibrium voltage level, and based on the relaxation time, controlling at least one characteristic of a charging process for the battery. Another approach includes usage of bi-directional pulses during the battery charging while the difference between the voltage relaxation curves at so called “partial equilibrium” and during current charge states of the battery is determined. Difference could be a difference in maximum voltage and voltage at state of partial equilibrium, difference in shapes of relaxation curve between partial equilibrium and current charge, and difference in rates of voltage decline. Practicing these approaches is costly since they require the use of a high resolution, fast sampling rate hardware.

### SUMMARY

According to an implementation of the present specification, there is provided a method, the method comprising: applying charging current to the battery; after applying the charging current, applying at least one discharging pulse to the battery; in response to applying the at least one discharging pulse, determining a first value and a second value of a relaxation voltage corresponding to the battery, wherein the first value corresponds to a maximum value of the relaxation voltage, and the second value corresponds to a value of the relaxation voltage determined after a particular wait period following the application of the at least one discharging pulse; determining a difference between the first value and the second value of the relaxation voltage; adapting one or more charging parameters based on the determined difference between the first value and the second value of the relaxation voltage; and charging the battery based on the adapted one or more charging parameters.

The determining the first value and the second value of the relaxation voltage may comprise measuring the relaxation voltage after application of the at least one discharging pulse to determine the maximum value of the relaxation voltage, and to determine the value of the relaxation voltage after the particular wait period.

The determining the second value of the relaxation voltage may comprise determining the particular wait period based on one or more parameters of the battery; and measuring the value of the relaxation voltage after the particular wait period following the application of the at least one discharging pulse.

The adapting the one or more charging parameters may comprise comparing the difference between the first value and the second value of the relaxation voltage with a threshold value; and adapting the one or more charging parameters based on the comparison.

The applying the charging current to the battery may comprise applying a plurality of charging pulses to the battery; and adapting the one or more charging parameters may comprise adapting one or more of: charging current, discharging current, end voltage corresponding to the discharging pulse, charging temperature, pause duration between the plurality of charging pulses and the at least one discharging pulse, and a number of charging pulses preceding the at least one discharging pulse.

The adapting the one or more charging parameters may comprise adapting a plurality of charging parameters based on one or more of: a target charging completion time period and a target life of the battery.

The adapting the one or more charging parameters may comprise selecting a value of the one or more charging parameters from a look-up table based on the determined difference between the first value and the second value of the relaxation voltage.

The method may further comprise determining a change in state of charge (SoC) of the battery relative to a change in open circuit voltage (OCV) of the battery during the charging of the battery, wherein adapting the one or more charging parameters may be further based on the change in SoC of the battery relative to the change in the OCV of the battery.

According to another implementation of the present specification, there is provided a controller to control charging of a battery, the controller comprising: a processing engine; and a non-transitory computer-readable storage medium configured to store instructions, wherein the instructions, in response to execution, by the processing engine, cause the controller to perform or control performance of operations that comprise: apply charging current to the battery; after application of the charging current, apply at least one discharging pulse to the battery; in response to application of the at least one discharging pulse, determine a first value and a second value of a relaxation voltage corresponding to the battery, wherein the first value corresponds to a maximum value of the relaxation voltage, and the second value corresponds to a value of the relaxation voltage determined after a particular wait period following the application of the at least one discharging pulse; determine a difference between the first value and the second value of the relaxation voltage; adapt one or more charging parameters based on the determined difference between the first value and the second value of the relaxation voltage; and charge the battery based on the adapted one or more charging parameters.

The operation to determine the first value and the second value of the relaxation voltage may comprise at least one operation to: measure the relaxation voltage after application of the at least one discharging pulse to determine the maximum value of the relaxation voltage, and to determine the value of the relaxation voltage after the particular wait period.

The operation to determine the second value of the relaxation voltage may comprise at least one operation to: determine the particular wait period based on one or more parameters of the battery; and measure the value of the relaxation voltage after the particular wait period following the application of the at least one discharging pulse.

The operation to adapt the one or more charging parameters may comprise at least one operation to compare the difference between the first value and the second value of the relaxation voltage with a threshold value; and adapt the one or more charging parameters based on the comparison.

The operation to apply the charging current to the battery may comprise an operation to apply a plurality of charging pulses to the battery; and the one or more charging parameters may comprise one or more of: charging current, discharging current, end voltage corresponding to the discharging pulse, charging temperature, pause duration between the plurality of charging pulses and the at least one discharging pulse, and a number of charging pulses preceding the at least one discharging pulse.

The operation to adapt the one or more charging parameters may comprise at least one operation to select a value of the one or more charging parameters from a look-up table based on the determined difference between the first value and the second value of the relaxation voltage.

The operations may further comprise: determine a change in state of charge (SoC) of the battery relative to a change in open circuit voltage (OCV) of the battery during the charging of the battery, wherein the one or more charging parameters may be adapted further based on the change in SoC of the battery relative to the change in the OCV of the battery.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 shows a block diagram of an example battery system, in accordance with a non-limiting implementation of the present specification.

FIG. 2 illustrates an example implementation of battery charging, in accordance with a non-limiting implementation of the present specification.

FIG. 3 shows a flowchart of an example method of adaptively charging a battery, in accordance with a non-limiting implementation of the present specification.

FIG. 4 illustrates example relaxation voltage measurements, in accordance with a non-limiting implementation of the present specification.

FIG. 5 illustrates a relationship between battery voltage and relaxation voltage for an example battery cell, in accordance with a non-limiting implementation of the present specification.

FIG. 6 illustrates charging current for an example battery cell, in accordance with a non-limiting implementation of the present specification.

FIG. 7 illustrates battery voltage for an example battery cell, in accordance with a non-limiting implementation of the present specification.

### DETAILED DESCRIPTION OF THE DISCLOSURE

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is provided to describe particular embodiments only and is not intended to limit any embodiments disclosed herein. As used herein, the singular forms “a,” “an,” and “the” are intended to include the plural forms as well, unless the context clearly indicates otherwise. It will be further understood that the terms “comprises,” “comprise,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless defined otherwise, all technical and scientific terms used herein have the same meaning as commonly understood by one of ordinary skill in the art to which this disclosure belongs.

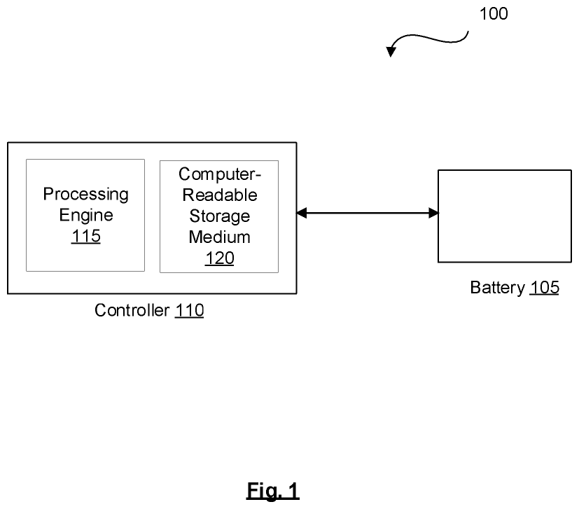

FIG. 1 shows an example battery system 100 in accordance with a non-limiting implementation of the present specification. The battery system 100 comprises a battery 105. In some implementations, the battery 105 may be a single battery cell. In some implementations, the battery 105 may be a battery pack which may comprise a plurality of rechargeable battery cells. In some implementations, the battery cells inside the battery pack may be arranged in many configurations, e.g., series-connected battery cells, parallel-connected battery cells, or a combination of series-connected and parallel-connected battery cells. In some implementations, the battery 105 may include a plurality of battery modules connected to each other in series or parallel, each battery module may further include battery cells arranged in different series and parallel configurations.

In some implementations, the battery 105 may comprise, but not limited to, lithium ion battery cell(s), lithium metal battery cell(s), sodium ion battery cell(s), nickel cadmium battery cell(s), nickel metal hydride battery cell(s), lead acid battery cell(s), solid state battery cell(s), or the like. The systems, methods, and devices described herein are not limited by the number or type of battery cells in the battery 105.

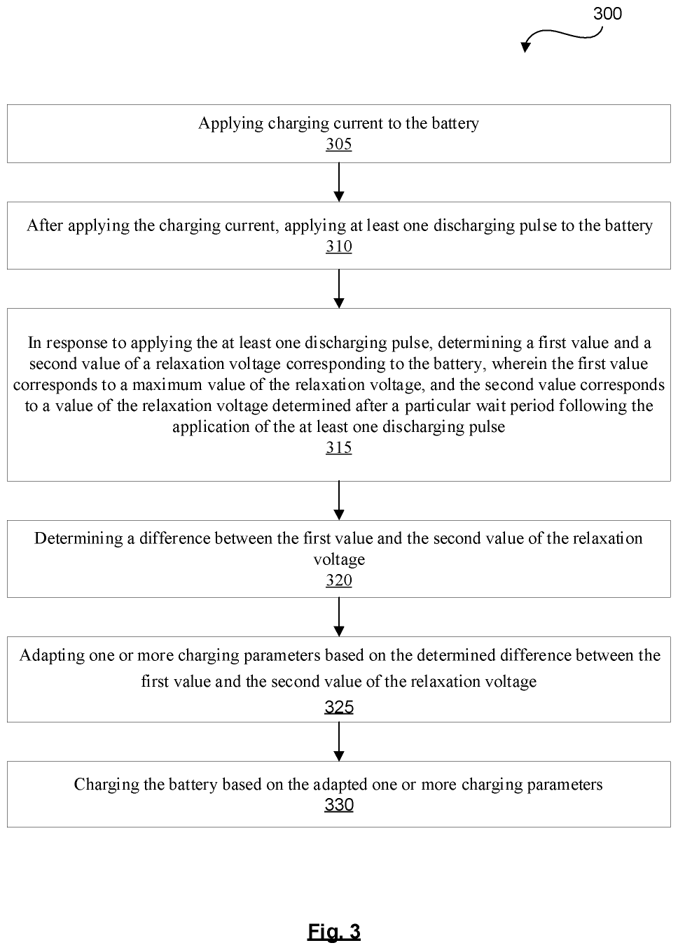

The battery system 100 further comprises a controller 110, which is operatively coupled to the battery 105. The controller 110 may control charging of the battery 105 in accordance with the methods described herein. For example, the controller may perform or control performance of operations of an example method 300 illustrated in FIG. 3. The controller 110 may comprise processing engine 115 to control charging of the battery 105 in accordance with the present specification. The controller may further comprise a non-transitory computer-readable storage medium 120 which may store instructions, which are executable by the processing engine 115 for the controller 110 to perform or control performance of operations in relation to charging of the battery 105 in accordance with the methods described herein. The computer-readable storage medium 120 may be a computer memory or storage device which may be any suitable memory apparatus, such as, but not limited to ROM, PROM, EEPROM, RAM, flash memory, disk drive and the like. In some examples, the processing engine 115 may execute the instructions stored in the computer-readable storage medium 120 which may cause the controller 110 to perform or control performance of an example method 300 illustrated in FIG. 3.

In some implementations, the controller 110 may facilitate charging of the battery 105 by employing any of the charging protocols, including but not limited to, CC-CV charging protocol, a pulse charging protocol, a constant current protocol, a constant voltage protocol, and the like.

In some implementations, the controller 110 may be a microcontroller and may comprise a central processing unit (e.g., processing engine 115) to process instructions and data, on-board memory to store instructions and data, a digital to analog converter for analog data conversion obtained from other modules of the battery system 100, and drive circuitry for control of the various modules of the battery system 100.

In some implementations, the controller 110 (e.g., processing engine 115) may also monitor (e.g., measure) various parameters of the battery 105, and use the monitored parameters to manage operation of the battery 105. The various parameters monitored by the controller 110 may comprise, but not limited to, voltage, current, state of charge (SoC), temperature, state of health, and the like. Additionally, the controller 110 (e.g., processing engine 115) may calculate various values, which include but not limited to charge current limit (CCL), discharge current limit (DCL), energy delivered since last charge or discharge cycle, internal impedance, and charge delivered or stored (coulomb counter) for the battery 105 as well as individual battery cells when the battery 105 is a battery pack. The controller 110 may comprise a communication interface to communicate with the hardware within the battery 105, and with load associated with the battery 105, such as, but not limited to, a mobile phone, electric vehicle, laptop, personal assistant device, or any other device or system to which the battery 105 supplies power.

In some implementations, the controller 110 may operate as a battery management system (BMS) of the battery 105, and perform all such functions as performed by the BMS. The BMS is essentially “brain” of a battery and controls charging and discharging of the battery among other operations. The controller 110 may act as an active BMS that adapts charging and discharging of the battery 105 in real-time by monitoring real-time electrochemical and macrokinetic processes that occur within the battery 105, and/or battery cells comprised within the battery pack 105. The controller 110 may perform active BMS functions (e.g., control charging and discharging of the battery pack 105) as described in commonly owned U.S. patent application Ser. No. 15/644,498 and commonly owned U.S. patent application Ser. No. 15/939,018.

The controller 110 may further comprise measurement circuitry (e.g., sensors and associated circuitry) to measure various parameters of the battery 105 and/or battery cells of the battery 105. In some implementations, the processing engine 115 may comprise the measurement circuitry. Various parameters that may be measured by the controller 110 or the processing engine 115 may comprise voltage (e.g., open circuit voltage (OCV), closed-circuit voltage (CCV), current, temperature, state-of-charge (SoC), and the like, for the battery 105 as well as individual battery cells of the battery 105. Simply stated, the controller 110 or the processing engine 115 may be configured to measure and determine values of various parameters (such as of current, voltage, temperature, SoC, or the like) for the battery 105. The controller 110 may comprise various sensors, such as, but not limited to, ammeter, voltmeter, temperature sensor, coulomb counter, and the like. In some examples, the controller 110 may also comprise some mechanical sensors such as, but not limited, to piezo-electric sensors (for determining battery swelling which is indicative of imbalance in the battery pack). In some implementations, the measurement circuitry and the sensors stated above may be implemented as components of the processing engine 115.

The battery system 100 may further comprise or be operatively coupled to a charging source (not shown in the drawings), which may be, for example, a dedicated adaptor, such as AC-to-DC wall adapter. In most cases, such adaptors are designed with the specific battery charging needs in mind, and thus the source capabilities of the charging source allow for proper capacity-based charging current of batteries, such as battery 105. In some implementations, the charging source, may be, for example, a non-dedicated adaptor, such as a universal charger not necessarily designed with any specific battery capacity in mind. As another example, the charging source may be a communication or computer bus voltage signal, intended to provide power to a number of devices connected in parallel or serially to the bus. One non-limiting example of this type of voltage source is a Universal Serial Bus (USB) connection, which provides a voltage bus (VBUS) signal from which a constrained amount of current may be drawn. Another example of the charging source can be a USB-C connector, which is a 24-pin USB connector system, which is distinguished by its two-fold rotational-symmetrical connector. In some implementations, the charging source may be a charging device for electric vehicles (e.g., charging station or an electric vehicle (EV) charger).

The controller 110 may interface with the charging source to obtain power to facilitate charging of the battery 105 in accordance with the present disclosure.

It is contemplated that a person of ordinary skill in the art may vary implementation of the battery system 100 and such variations are within the scope of the present disclosure. For example, the controller 110 may be implemented as a component of the charging source. In some implementations, the controller 110 may be housed in a housing of the charging source. Similarly, the controller 110 may be implemented as a component of the battery 105. In some implementations, the controller 110 may be housed in a housing of the battery 105. In some implementations, the controller 110 may be implemented as a separate module (e.g., add-on module) which may interface with the charging source to perform adaptive charging of the battery 105 in accordance with the methods described herein.

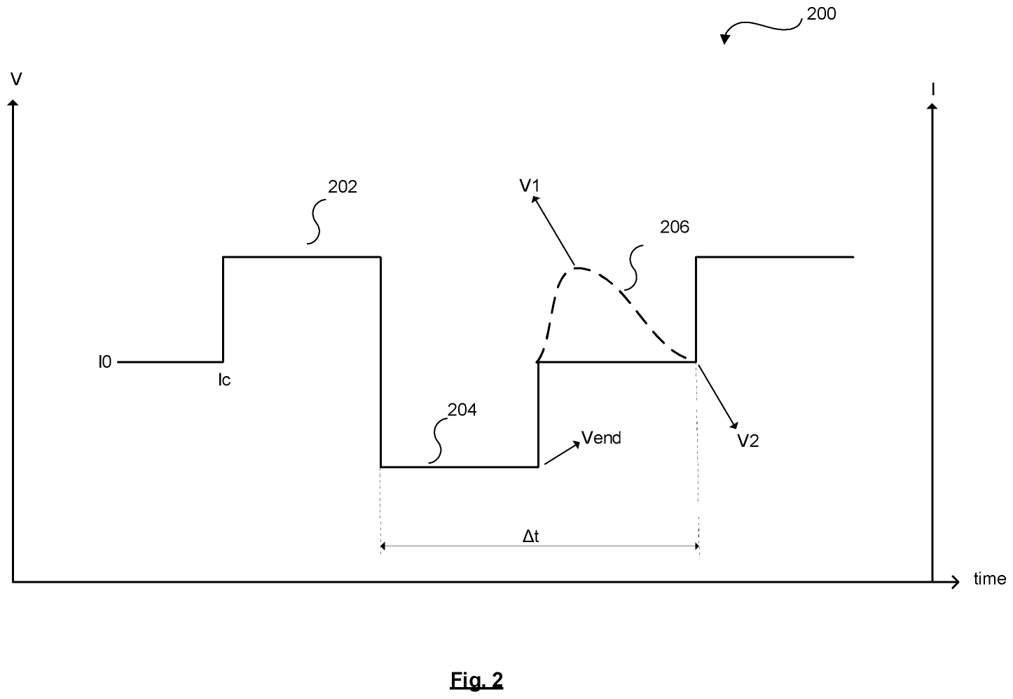

FIG. 2 illustrates an example implementation 200 of battery charging, in accordance with a non-limiting implementation of the present specification.

As can be seen in FIG. 2, to charge the battery, the charging current 202 is applied to a battery (e.g., battery 105). In some implementations, a sequence (e.g., train) of charging pulses is applied to the battery. In some implementations, a constant current (CC) may be applied to the battery. In other words, in some implementations, the battery charging may be initiated in a constant current (CC) charging mode. For example, the controller 110 may apply the charging current to charge the battery 105.

In some implementations, to initiate charging of the battery, the charging parameters of the charging current or charging pulses, such as but not limited to frequency, amplitude, pulse width, or the like, may be determined based on battery characterization. For example, the controller 110 may determine initial charging parameters on type of the battery (e.g., battery 105), battery specifications, charging hardware (e.g., charging source) specifications or limitations, or the like.

After application of the charging current, at least one discharging pulse 204 may be applied to the battery. In some implementations, the controller 110 may apply the charging current to the battery 105 for a particular amount of time before applying the at least one discharging pulse 204. For example, the controller 110 may apply the train of charging pulses to the battery 105 for the particular amount of time before deciding to apply the at least one discharging pulse.

In some implementations, the controller 110 may determine when to apply the at least one discharging pulse based on one or more battery parameters, such as but not limited to, state of charge (SoC) of the battery 105. In some implementations, the controller 110 may decide to apply the at least one discharging pulse after detecting that the SoC of the battery has changed by a particular amount. For example, after every 1% change in SoC of the battery 105, the controller 110 may apply one or more discharging pulses to the battery 105. In other examples, the controller 110 may apply the discharging pulse to the battery 105 after every 0.5%, 2%, 5%, or any other percentage change in SoC of the battery 105.

In some implementations, the controller 110 may determine parameters of the discharging pulse 204 to be applied based on the battery measurements which may include but not limed to SoC of the battery 105, temperature, or voltage measurements such as open circuit voltage (OCV) corresponding to the battery 105, or the like. In some implementations, the controller 110 may select pulse parameters such as amplitude, pulse width, or the like, of the discharging pulse 204 from a look-up table which may be generated during battery characterization. In some implementations, the controller 110 may determine parameters of the discharging pulse 204 to be applied to the battery 105 based on parameters of charging pulses, preceding the discharging pulse 204, applied to the battery 105.

In response to applying the discharging pulse 204, the controller 110 may determine a first value (V1) and a second value (V2) of a relaxation voltage of the battery 105. The relaxation voltage corresponds to an open circuit voltage (OCV) of the battery 105. The first value corresponds to a maximum value of the relaxation voltage, and the second value corresponds to a value of the relaxation voltage determined after a particular wait period following the application of the discharging pulse 204.

After applying the discharging pulse 204, the controller 110 may interrupt a flow of charging current or discharging current into or from the battery 105 for the purposes of determining relaxation voltage (OCV) values. In some implementations, the controller 110 may continuously measure relaxation voltage of the battery 105 during the relaxation time (e.g., time between the end of the discharging pulse and beginning of next charging pulse or charging current applied to the battery 105) to determine the maximum value of the relaxation voltage (V1) and to determine the value of the relaxation voltage (V2) after the particular wait period. The relaxation voltage values measured or determined after the application of the discharging pulse are indicative of a state of health of the battery, and may be used to adapt the charging parameters to optimize the charging process in terms of life of the battery or charging speed of the battery.

As stated previously, the controller 110 may determine the first value (V1) of the relaxation voltage, which is a maximum value of the relaxation voltage, illustrated as V1 on the relaxation voltage curve 206. The controller 110 may further determine the second value (V2) of the relaxation voltage, illustrated as V2 on the relaxation voltage curve 206, which is a value determined after a particular wait period following the application of the discharging pulse. For example, the controller 110 may wait for a particular time period after applying the discharging pulse, and determine the value of the relaxation voltage after time period Δt (illustrated in FIG. 2) following the application of the discharging pulse 204. In some other implementations, the controller 110 may wait for the wait period Δt from the end of the discharging pulse 204 before measuring the second value of the relaxation voltage. In some implementations, the controller 110 may determine the wait period Δt based on one more parameters of the battery, which may include but not limited to state of the battery, age of the battery, health of the battery, type of the battery, battery chemistry, state of the battery (SoC) or the like. Alternatively, or additionally, the controller 110 may determine the wait period Δt based on one or more charging parameters, which may include, but not limited to amplitude, frequency, pulse width, or the like of the charging pulses.

In some implementations, the wait period following the application of the discharging pulse 204 to determine the second value of the relaxation voltage is dynamic and may vary based on state of charge (SoC) of the battery. For example, when the SoC of the battery is having a first value (e.g., battery at 10% SoC), the controller 110 may wait for a first time period (first wait period) after application of the discharging pulse before measuring the second value of the relaxation voltage of the battery 105, and when the SoC of the battery is having a second value (e.g., battery at 40% SoC), the controller 110 may wait for a second time period (second wait period) after application of the discharging pulse before measuring the second value of the relaxation voltage of the battery 105. The first time period (first wait period) may be different than the second time period (second wait period).

Further, the controller 110 may further determine a difference (Vdiff) between the first value (V1) and the second value (V2) of the relaxation voltage Based on the determined difference (Vdiff), one or more charging parameters may be adapted, and based on the adapted charging parameters, the battery 105 may be charged.

In some implementations, the controller 110 may compare the difference (Vdiff) with a threshold value (Vthrs), and based on the comparison of the Vdiff and Vthrs, the controller 110 may adapt the one or more charging parameters. The Vthrs may be a desired Vdiff value, and the desired Vdiff value may vary with the OCV value of the battery. In some implementations, the open circuit voltage (OCV) of the battery at the end of the discharging pulse 204 may be determined, and Vthrs or desired Vdiff value may be selected for comparison with the actual Vdiff value based in the measured Vend. In some implementations, the mapping of battery voltage (OCV) values at the end of the discharging pulse i.e., Vend values, and Vthrs values may be stored and implemented as a look-up table by the controller 110. One such example look-up table is provided below as Table 1. Such a look-up table may be used by the controller 110 to compare the actual Vdiff and Vthrs (e.g., desired Vdiff) to adapt the charging process or charging parameters in accordance with the present disclosure.

For example, if Vdiff is substantially equal to Vthrs, the controller 110 may determine that the discharging pulse 204 provided ideal compensation, and the charging parameters may not be modified or adapted. In other words, the Vdiff being substantially equal to Vthrs is indicative of the relaxation curve 206 being an ideal relaxation curve.

In another example, if Vdiff is smaller than the Vthrs, the controller 110 may determine that the discharging pulse 204 did not provide the sufficient compensation, and the charging parameters may be modified. In other words, the Vdiff being smaller than the Vthrs is indicative of the relaxation curve being not an ideal relaxation voltage curve (being a poor relaxation curve). Similarly, if Vdiff is larger than the Vthrs, it is being determined that the discharging pulse 204 overcompensated for the charging current, and the charging parameters may be modified. In other words, the Vdiff being smaller than the Vthrs is indicative of the relaxation voltage curve being not an ideal relaxation curve (being too good voltage relaxation curve).

In some implementations, based on Vdiff or based on comparison of Vdiff and Vthrs, the controller 110 may adapt the one or more charging parameters, which may include, but not limited to, charging current, discharging current, end voltage (Vend) corresponding to the discharging pulse, temperature, pause duration between the plurality of charging pulses and at least one discharging pulse, and a number of charging pulses preceding the at least one discharging pulse.

In some implementations, the controller 110 may implement a look-up table, and select values of the charging parameters to be adapted from the look-up table based on the Vdiff. The look-up table may be generated or build during the battery characterization. Different look-up tables for different battery types may be generated and implemented. The look-up table may specify the values of the charging parameters in relation to Vdiff and SoC of the battery. Such charging parameters whose values may be defined in the look-up table may include but not limited to but not limited to, charging current, discharging current, end voltage (Vend) corresponding to the discharging pulse, temperature, pause duration between the plurality of charging pulses and at least one discharging pulse, and a number of charging pulses preceding the at least one discharging pulse.

In some implementations, the charging parameters that may be adapted includes a shape of the discharging pulse. For example, based on the Vdiff or based on comparison of Vdiff and Vthrs, the discharging pulse(s) that are applied to the battery during the charging cycle may be selected to have a shape, but not limited to, from, sine wave, square wave, sawtooth wave, triangle wave, trapezoidal wave etc.

In some examples, based on the Vdiff, the controller 110 may vary pulse width, frequency, amplitude, duty cycle, or the like of the charging pulses to be subsequently applied to the battery 105.

In some implementations, the controller 110 may adapt the charging parameters in a particular priority order. For example, if Vdiff is less than Vthrs, the controller 110 may adapt the charging parameters in the following priority order: (i) increase in charging current (Ic)>(ii) decrease in discharging current corresponding to the discharging pulse (Id)>(iii) increase in discharging pulse end voltage (Vend). This priority order of adapting charging parameters is defined to obtain fast charging of the battery while improving the life of the battery. Similarly, if Vdiff is greater than Vthrs, the charging parameters may be adapted in the following priority order: (i) increase in discharging current (Id)>(ii) decrease in Vend>(iii) decrease in charging current (Ic). This priority order of adapting charging parameters is defined to obtain fast charging of the battery while improving the life of the battery. In some implementations where the fast charging of the battery is a lower priority than the life of the battery, the above stated priority orders may be changed.

In some implementations, if Vdiff is smaller or greater than Vthrs by a particular value (e.g., hysteresis value), the charging parameters may not be adapted. In other words, the controller 110 may determine whether the difference between Vdiff and Vthrs is more than a particular value (hysteresis value), and only in response to determining that the difference between Vdiff and Vthrs is more than the particular value, the charging parameters may be adapted. If the controller 110 determines that the difference between the Vdiff and Vthrs is less than or equal to the hysteresis value, the controller 110 may not modify or adapt the charging parameters.

In some implementations, the controller 110 may implement additional control loop to adapt the charging parameters. For example, the controller 110 may determine a change in state of charge (SoC) of the battery relative to a change in open circuit voltage (OCV) of the battery during the charging of the battery. Based on Vdiff, and based on change in the SoC of the battery relative to the change in OCV of the battery, the controller 110 may adapt the one or more charging parameters.

In some implementations, the controller 110 may use a look-up table to determine if during charging of the battery, the change in SoC of the battery per unit change in OCV matches the expected value. If the change in SoC of the battery per unit change in OCV does not meet the expected value, the controller 110 may adapt the charging parameters. For example, if the 5 millivolt change in OCV of the battery should have ideally resulted in 2% change in SoC during a particular phase of charging, however the actual change in SoC is determined to be 1.5%, the controller 110 may adapt the charging parameters in a similar manner as described above. For example, the charging current (Ic) may be increased, the discharging current (Id) may be decreased, and discharging pulse end voltage (Vend) may be increased. Similarly, in another example, if the actual change in SoC is 2.5% (different from expected change of 2%), the controller 110 may adapt the charging parameters then too. For example, the charging current (Ic) may be decreased, the discharging current (Id) may be increased, and Vend may be increased too.

In some implementations, the controller 110 may generate a reference SoC vs OCV curve (corresponding to expected SoC values), and an actual SoC vs OCV curve. Further, the controller 110 may compare the reference SoC vs OCV curve and the actual SoC vs OCV curve to adapt the charging parameters. For example, the controller 110 may adapt the charging parameters for the actual SoC vs OCV curve to follow the reference SoC vs OCV curve.

In some implementations, the reference SoC vs OCV curve may be dynamic and may vary based on, but not limited to, age of the battery, type of the battery, total charge_in (during lifetime of the battery) and total charge_out (during the lifetime of the battery). The values corresponding to the SoC vs OCV curve may be stored in a lookup table, and the controller 110 may refer to the stored lookup table values to adapt the charging parameters.

The use of multiple control loops (e.g., based on Vdiff, and based on SoC vs OCV) to adapt the charging parameters may be beneficial since the adaptation in charging parameters suggested by each of the control loop may be compared and a final determination to adapt the charging parameters may be done accordingly.

In some implementations, prior to initializing the charging parameters adaptation (e.g., at the beginning of the charging cycle), the controller 110 may ramp up the value of the charging current (Ic) in a number of incremental steps. For example, the controller 110 may ramp the value of the IC to the desired value in a series of incremental steps. Once the Ic is at the desired value, the controller 110 may initiate charging parameters adaptation.

Similarly, in some implementations, following the charging parameters adaptation, at the end of the charging cycle, the controller 110 may ramp down the charging current Ic down in a series of decremental steps. In some implementations, the controller may perform ramping up/ramping down of the charging current Ic at any time during the charging cycle (e.g., at any time during charging parameters adaptation).

In some implementations, the controller 110 may carry out a gradient search to find a combination of charging parameters that will result in an ideal relaxation voltage curve and effective charging of the battery per the desired specifications. For example, the controller 110 may adapt a plurality of charging parameters based on a target charging completion time period or a target life of the battery. In other words, in addition to Vdiff, the controller 110 may take into consideration the target charging completion time period (e.g., desired charging time) of the battery 105, or a target life (e.g., desired cycle life) of the battery 105 while adapting the charging parameters.

In some implementations, the controller 110 may apply weight coefficients to various charging parameters (while adapting) based on various criteria such as but not limited to the desired speed of charging, the desired life of the battery etc.

FIG. 3 is a flowchart illustrating an example method to adaptively charge the battery in accordance with a non-limiting implementation of the present specification. The method 300 illustrated in FIG. 3 may be performed by the controller 110.

The method 300 begins at 305, where charging current is applied to the battery. In some examples, constant current (CC) is applied to the battery. In some examples, a train of charging pulses is applied to the battery.

At 310, after application of the charging current, at least one discharging pulse is applied to the battery. As described previously, in some implementations, the discharging pulse may be applied after it is determined that the value of the SoC has changed by a particular amount.

At 315, in response the at least one discharging pulse being applied, a first value and a second value of a relaxation voltage corresponding to the battery are determined. The first value corresponds to a maximum value of the relaxation voltage, and the second value corresponds to a value of the relaxation voltage determined after a particular wait period following the application of the at least one discharging pulse.

At 320, a difference between the first value and the second value of the relaxation voltage may be determined. In some implementations, the difference between the first value and the second value may be compared with a threshold value.

At 325, one or more charging parameters are adapted based on the determined difference between the first value and the second value of the relaxation voltages. In some implementations, the charging parameters may be adapted based on the comparison of the difference between the first value and the second value with the threshold value.

At 330, the battery may be charged based on the adapted one or more charging parameters. For example, the battery may be charged with the adapted charging parameters until the charging parameters are adapted again based on the relaxation voltage measurements as described herein. In other words, the charging parameters adaptation is a continuous process which may be performed for several times in a same charging cycle. For example, as stated above, the discharging pulse may be applied to the battery when the SoC changes by a particular value or amount (e.g., 1%, 2%, 5%, or the like). Therefore, the charging parameters adaptation may be performed every time the SoC changes by the particular value or amount (e.g., 1%, 2%, 5%, or the like).

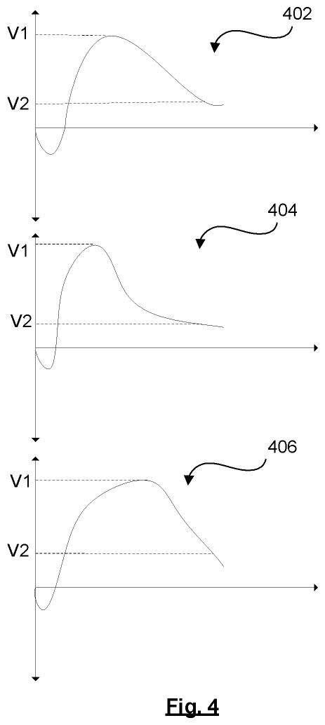

FIG. 4 illustrates example relaxation voltage curves of the battery (e.g., battery 102) depicting change in the relaxation voltage of the battery after application of the discharging pulse as described above in accordance with the present disclosure. As can be seen in FIG. 4, the example voltage curves 402, 404, and 406 are distinct from each other in terms of form, shape, and rate of decay of the relaxation voltage. However, the difference between the first voltage V1, corresponding to maximum value of the relaxation voltage, and the second voltage V2, the value measured after a particular wait time is substantially same. Therefore, the techniques of the present disclosure do not take into consideration the form, shape, and rate of decay of the relaxation voltage (corresponding to the relaxation voltage curve) to adapt the charging process, e.g., adapt the charging parameters. In other words, the battery charging adaptation methods disclosed herein are independent of the form, shape, and rate of decay of the relaxation voltage. As described previously, the disclosed systems and methods adapt the charging parameters by determining a difference between two battery relaxation voltage values, one of which is the maximum value of the relaxation voltage of the battery, and another is the value of the relaxation voltage of the battery determined after waiting for a particular wait period following the application of the discharging pulse.

As described above, a look-up table may be implemented to adapt the charging process based on the methods disclosed herein. One such example look-up table (Table 1) is depicted below which was generated for Panasonic NCR 18650BD cell.

| OCV | Vdiff (V1 − V2) |
|---|---|
| (mv) | (mV) |
| 2500 | 5 |
| 3400 | 7 |
| 3500 | 8 |
| 3600 | 9 |
| 3700 | 10 |
| 3750 | 11 |
| 3800 | 11 |
| 3900 | 11 |
| 4000 | 10 |
| 4100 | 8 |
| 4230 | 7 |

The example Table 1 includes values of OCV of the battery (Panasonic NCR 18650BD cell) mapped to desired Vdiff (V1-V2) values. The OCV values in the table 1 correspond to the OCV of the battery as measured at the end of the discharging pulse (e.g., Vend in FIG. 2). The Vdiff values in the Table 1 corresponds to a desired voltage difference between V1 (maximum relaxation voltage value after application of the discharging pulse) and V2 (relaxation voltage value determined after the particular wait time) for the particular OCV value.

When the actual Vdiff value deviates from the desired Vdiff value for the corresponding OCV value as specified in the table 1, the charging parameters to charge the battery were adapted. For example, when the OCV of the battery at the end of the discharging pulse (Vend) was measured to 2500 mv, but actual Vdiff value was measured to be different than the desired Vdiff value 5 mv (as mapped to OCV value of 2500 my), then the charging parameters were adapted. For example, one or more of pulse width, amplitude, or frequency of charging pulses of subsequent charging sequences to be applied to the battery were adapted.

In other instances, when the actual Viff value was determined to be same as desired V diff value specified in Table 1, charging parameters were considered to be optimal and were not modified. Such adaptive charging of the battery cell as disclosed herein resulted in not only increased cycle life of the battery, but also enabled fast charging of the battery without damaging the battery.

The data included in the example Table 1 corresponds to a certain state of cycling lide for the battery. The values in the Table 1 need to be adjusted for different cycle states of the battery. For example, the data for the battery in the first cycle of life will be different than the data for the battery in the hundredth cycle of life. Additionally, the data may be modified based on other charging parameters, such as temperature at which the battery is being charged. Such adjustments in the data may be defined during the battery characterization.

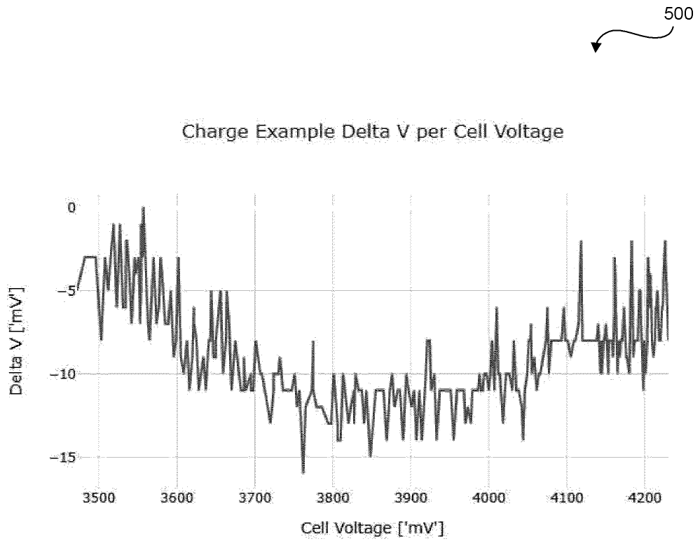

The OCV to Vdiff (desired Vdiff) mapping provided in Table 1 is also illustrated in FIG. 5 which shows an example graph 500 depicting a relationship between various OCV values (Vend values) and corresponding desired Vdiff values for Panasonic NCR 18650BD cell. This graph was generated in response to the battery characterization.

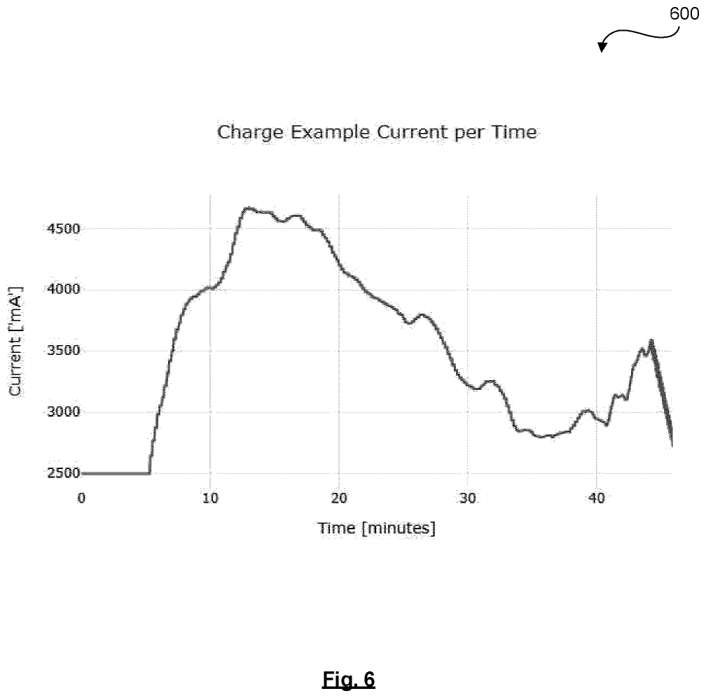

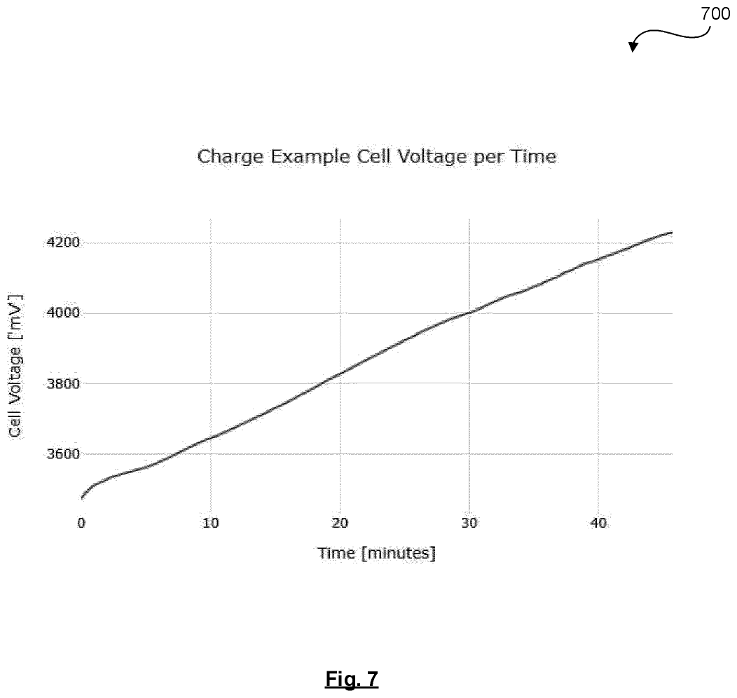

Example graph 600 depicting a variation in the charging current (adaptive charging current) to charge the Panasonic NCR 18650BD cell based on the techniques of this disclosure is illustrated in FIG. 6. Similarly, another example graph 700 depicting a change in cell voltage (OCV) for the Panasonic NCR 18650BD cell charged with the methods disclosed herein is illustrated in FIG. 7.

It is contemplated that table 1 and graphs illustrated in FIG. 5-7 disclosed herein are examples only and should not be construed to limit the scope and spirit of this disclosure.

It is further contemplated that charging adaptation process based on the techniques disclosed herein, is more robust and easier to implement as compared to existing methods of adaptive battery charging that takes form, shape, and rate of decay of relaxation voltage or equilibrium value or relaxation voltage into consideration to adapt the battery process.

The methods disclosed herein provides simpler and cheaper way of adapting the battery charge by use of relaxation voltage measurement during a predetermined period at OFF time. The disclosed method includes using the value of voltage difference between maximum of relaxation voltage and voltage at the end of the predetermined measurement time period. The predetermined measurement time period is defined during battery characterization process and could be different at different states of charge of the battery. Such voltage measurements for the battery charging adaptation could be performed with use of a commonly available hardware.

It will be appreciated that the modules, processes, systems, and sections described above can be implemented in hardware, hardware programmed by software, software instructions stored on a non-transitory computer readable medium or a combination of the above. A system and/or a module as described above, for example, can include a processor configured to execute a sequence of programmed instructions stored on a non-transitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a non-transitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a non-transitory computer readable medium).

Furthermore, embodiments of the disclosed method, system, and computer program product (or software instructions stored on a non-transitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for event updates management and control.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method to charge a battery, the method comprising:
applying charging current to the battery;
after applying the charging current, applying at least one discharging pulse to the battery;
in response to applying the at least one discharging pulse, determining a first value and a second value of a relaxation voltage corresponding to the battery, wherein the first value corresponds to a maximum value of the relaxation voltage, and the second value corresponds to a value of the relaxation voltage determined after a particular wait period following the application of the at least one discharging pulse;
determining a difference between the first value and the second value of the relaxation voltage;
adapting one or more charging parameters based on the determined difference between the first value and the second value of the relaxation voltage; and
charging the battery based on the adapted one or more charging parameters.

2. The method of claim 1, wherein determining the first value and the second value of the relaxation voltage comprises:
measuring the relaxation voltage after application of the at least one discharging pulse to determine the maximum value of the relaxation voltage, and to determine the value of the relaxation voltage after the particular wait period.

3. The method of claim 1, wherein determining the second value of the relaxation voltage comprises:
determining the particular wait period based on one or more parameters of the battery; and
measuring the value of the relaxation voltage after the particular wait period following the application of the at least one discharging pulse.

4. The method of claim 1, wherein adapting the one or more charging parameters comprises:
comparing the difference between the first value and the second value of the relaxation voltage with a threshold value; and
adapting the one or more charging parameters based on the comparison.

5. The method of claim 1, wherein:
applying charging current to the battery comprises applying a plurality of charging pulses to the battery; and
adapting the one or more charging parameters comprises adapting one or more of: charging current, discharging current, end voltage corresponding to the discharging pulse, charging temperature, pause duration between the plurality of charging pulses and the at least one discharging pulse, and a number of charging pulses preceding the at least one discharging pulse.

6. The method of claim 1, wherein adapting the one or more charging parameters comprises:
adapting a plurality of charging parameters based on one or more of: a target charging completion time period and a target life of the battery.

7. The method of claim 1, wherein adapting the one or more charging parameters comprises:
selecting a value of the one or more charging parameters from a look-up table based on the determined difference between the first value and the second value of the relaxation voltage.

8. The method of claim 1, further comprising:
determining a change in state of charge (SoC) of the battery relative to a change in open circuit voltage (OCV) of the battery during the charging of the battery,
wherein adapting the one or more charging parameters is further based on the change in SoC of the battery relative to the change in the OCV of the battery.

9. A controller to control charging of a battery, the controller comprising:
a processing engine; and
a non-transitory computer-readable storage medium configured to store instructions, wherein the instructions, in response to execution, by the processing engine, cause the controller to perform or control performance of operations that comprise:
apply charging current to the battery;
after application of the charging current, apply at least one discharging pulse to the battery;
in response to application of the at least one discharging pulse, determine a first value and a second value of a relaxation voltage corresponding to the battery, wherein the first value corresponds to a maximum value of the relaxation voltage, and the second value corresponds to a value of the relaxation voltage determined after a particular wait period following the application of the at least one discharging pulse;
determine a difference between the first value and the second value of the relaxation voltage;
adapt one or more charging parameters based on the determined difference between the first value and the second value of the relaxation voltage; and
charge the battery based on the adapted one or more charging parameters.

10. The controller of claim 9, wherein the operation to determine the first value and the second value of the relaxation voltage comprises at least one operation to:
measure the relaxation voltage after application of the at least one discharging pulse to determine the maximum value of the relaxation voltage, and to determine the value of the relaxation voltage after the particular wait period.

11. The controller of claim 9, wherein the operation to determine the second value of the relaxation voltage comprises at least one operation to:
determine the particular wait period based on one or more parameters of the battery; and
measure the value of the relaxation voltage after the particular wait period following the application of the at least one discharging pulse.

12. The controller of claim 9, wherein the operation to adapt the one or more charging parameters comprises at least one operation to:
compare the difference between the first value and the second value of the relaxation voltage with a threshold value; and
adapt the one or more charging parameters based on the comparison.

13. The controller of claim 9, wherein:
the operation to apply charging current to the battery comprises an operation to apply a plurality of charging pulses to the battery; and
the one or more charging parameters comprise one or more of: charging current, discharging current, end voltage corresponding to the discharging pulse, charging temperature, pause duration between the plurality of charging pulses and the at least one discharging pulse, and a number of charging pulses preceding the at least one discharging pulse.

14. The controller of claim 9, wherein the operation to adapt the one or more charging parameters comprises at least one operation to:
select a value of the one or more charging parameters from a look-up table based on the determined difference between the first value and the second value of the relaxation voltage.

15. The controller of claim 9, wherein the operations further comprise:
determine a change in state of charge (SoC) of the battery relative to a change in open circuit voltage (OCV) of the battery during the charging of the battery,
wherein the one or more charging parameters are adapted further based on the change in SoC of the battery relative to the change in the OCV of the battery.
